(19) United States
(12) Patent Application Publication
(10) Pub. No.: US 2023/0216110 A1
(43) Pub. Date: Jul. 6, 2023

(54) SAFETY STRUCTURE FOR VEHICLE BATTERY PACK

(71) Applicants: Hyundai Motor Company, Seoul (KR); Kia Corporation, Seoul (KR)

(72) Inventors: Tae Hyuck KIM, Asan-si (KR); Jae Hyeon JU, Seoul (KR); Chang Mo SUNG, Gunpo-si (KR); Mee Sun OH, Hwaseong-si (KR); Min Seok SEO, Gimpo-si (KR)

(73) Assignees: Hyundai Motor Company, Seoul (KR); Kia Corporation, Seoul (KR)

(21) Appl. No.: 17/941,428

(22) Filed: Sep. 9, 2022

(30) Foreign Application Priority Data
Jan. 6, 2022 (KR) 10-2022-0002247

(51) Int. Cl. H01M 10/658; H01M 50/204; H01M 50/276; H01M 50/258; H01M 50/264; H01M 50/224; H01M 50/293

(52) U.S. Cl. CPC H01M 10/658; H01M 50/204; H01M 50/276; H01M 50/258; H01M 50/264; H01M 50/224; H01M 50/293; B60R 16/033

(57) ABSTRACT

A safety structure for a vehicle battery pack includes: a battery module each including a plurality of battery cells stacked between opposite endplates; a lower casing which covers a lower side of the battery modules that are two-dimensionally arrayed; an upper cover coupled to an upper side of the lower casing and covering an upper side of the battery modules; and first cut-off pads, each of which is made of a heat-resistant and insulating material, disposed in a portion where a gap between the endplate of the battery module and the lower casing becomes locally narrow.

### CROSS REFERENCE TO RELATED APPLICATION

The present application claims priority to Korean Patent Application No. 10-2022-0002247, filed Jan. 6, 2022, the entire contents of which is incorporated herein for all purposes by this reference.

### TECHNICAL FIELD

The disclosure relates to technology for improving the safety of a vehicle battery pack.

### BACKGROUND

A high-voltage battery for supplying power to a vehicle is mounted in the form of a battery pack to a recent electric vehicle or the like.

The battery pack includes a plurality of battery modules accommodated in a battery casing divided into a lower casing and an upper cover. Each battery module includes a plurality of battery cells.

Further, the battery pack includes a plurality of longitudinal members, a plurality of cross members, etc., between the battery modules so as to support the battery modules loaded therein and secure the rigidity of the battery pack.

Therefore, there are many adjacent portions leaving only a little gap from the battery module between the upper cover and the battery module, between the lower casing and the battery module, between the longitudinal member or the cross member and the battery module, inside the battery pack.

The endplate or clamp of the battery module, the lower casing, the upper cover, the longitudinal member, the cross member, etc., are generally made of a metallic material, and therefore the foregoing portion leaving only a little gap from the battery module may potentially serve as a capacitor.

Meanwhile, the battery cell may generate heat, off-gassing, or the like may occur inside the battery pack for some reason. In this case, when the off-gas together with foreign materials enter the gap of the foregoing portion that functions as a capacitor, an insulating distance of the gap is effectively decreased, and therefore electric charges accumulated in the gap between the battery module and its adjacent components may form an electric arc, thereby leading to thermal runaway of the battery pack and causing fire to break out.

Matters described as the related art are provided merely for promoting understanding for the background of the disclosure, and should not be taken as the prior art already known to a person having ordinary knowledge in the art.

### SUMMARY

The disclosure is to provide a safety structure for a vehicle battery pack, in which the possibility of an electric arc is eliminated between a battery module and its adjacent components inside the battery pack, thereby effectively decreasing or preventing the thermal runaway and fire of the battery pack, and ultimately improving the battery pack in safety significantly.

According to an aspect of the disclosure, a safety structure for a vehicle battery pack includes a plurality of battery modules each including a plurality of battery cells stacked between opposing endplates are assembled; a lower casing which covers a lower side of the battery modules that are two-dimensionally arrayed; an upper cover coupled to an upper side of the lower casing and covering an upper side of the battery modules; and first cut-off pads, each of which is made of an insulating material, disposed between the endplates of the battery modules and the lower casing.

The first cut-off pads may be disposed in portions where gaps between the endplates of the battery modules and the lower casing becomes locally narrow.

The first cut-off pads may be attached to a top surface of the lower casing and spaced from each other.

Each battery module may be provided as a single body by clamps respectively, connecting the opposing endplates at upper and lower sides, and a second cut-off pad made of insulating material may be disposed in a space between the lower casing and the clamps of each battery module.

The second cut-off pad may be attached on the top surface of the lower casing and disposed between, and spaced from, the first cut-off pads.

The safety structure may further include a third cut-off pad made of an insulating material and disposed on an inner surface of the upper cover facing the upper side of the battery modules.

A plurality of longitudinal members and a plurality of cross members may be respectively mounted between the battery modules of the battery pack; and whichever of the longitudinal members and the cross members is adjacent to a lateral end portion of the endplates of each battery module may be provided with a fourth cut-off pad made of insulating material.

A mounting bracket, to which electrical parts needed for the battery pack are mounted, may be disposed above the two-dimensionally arrayed battery modules; the electrical parts may be mounted to an upper side of the mounting bracket; and a fifth cut-off pad made of an insulating material may be disposed on a bottom surface of the mounting bracket.

The electric parts mounted to the upper side of the mounting bracket may include a power relay assembly (PRA).

Further, according to an aspect of the disclosure, a safety structure for a vehicle battery pack includes: a plurality of battery modules, each including a plurality of overlapped battery cells, opposite sides of which are covered with endplates, the endplates being connected by clamps at the upper and lower sides; a lower casing covering the battery modules from below; an upper cover coupled to the lower casing and covering the battery modules from above; a plurality of longitudinal members and a plurality of cross members coupled to the lower casing and each positioned between the plurality of battery modules; and a plurality of cut-off pads made of an insulating material and disposed in at least one of the lower casing, the upper cover, the longitudinal members or the cross members to face portions adjacent to the endplates and clamps of the battery module.

The cut-off pads may include a first cut-off pad disposed between the lower casing and the endplate of the battery module; a second cut-off pad disposed between the lower casing and the clamp of the battery module; a third cut-off pad disposed on an inner surface of the upper cover; and a fourth cut-off pad disposed between the endplate of the battery module and an adjacent longitudinal member among the longitudinal members or an adjacent cross member among the cross members.

The first cut-off pad may extend lengthways along a direction in which the battery modules are overlapped, facing toward the opposite end portions of the endplate.

The second cut-off pad may extend lengthways along the direction in which the battery modules are overlapped, and may be disposed between the first cut-off pads.

A mounting bracket, to which electrical parts needed for the battery pack are mounted, may be disposed above the two-dimensionally arrayed battery modules; the electrical parts may be mounted to a space between the mounting bracket and the upper cover; and a fifth cut-off pad made of a heat-resistant and insulating material may be disposed on a bottom surface of the mounting bracket.

The electric parts mounted to a space between the mounting bracket, and the upper cover may include a PRA.

Whichever of the lower casing, the upper cover, the longitudinal member, and the cross member needs to be provided with the cut-off pad may include a portion made of a metallic material and thus potentially functions as a capacitor together with the endplate or clamp of the battery module.

The cut-off pad may be provided in whichever portion of the lower casing, the upper cover, the longitudinal member and the cross member where an electric arc causing fire is highly likely to be formed between the endplates or clamps of each battery module, so as to fundamentally prevent the formation of the electric arc.

### BRIEF DESCRIPTION OF THE DRAWINGS

FIG. 1 illustrates a structure for a battery pack of a vehicle according to an exemplary embodiment of the disclosure,

FIG. 2 illustrates a battery module accommodated in the battery pack of FIG. 1,

FIG. 3 illustrates an endplate and a clamp of the battery module of FIG. 2 excluding a battery cell,

FIG. 4 is a plan view of the battery pack of FIG. 1,

FIG. 5 is a sectional view taken along line V-V of FIG. 4,

FIG. 6 illustrates an embodiment that a first cut-off pad and a second cut-off pad are applied to a lower casing according to an exemplary embodiment of the disclosure,

FIG. 7 illustrates an embodiment that a third cut-off pad is applied to an upper cover according to an exemplary embodiment of the disclosure,

FIG. 8 is a sectional view taken along line V-V line of FIG. 4, to which first to fourth cut-off pads are applied according to an exemplary embodiment of the disclosure, and

FIG. 9 is a sectional view taken along line IX-IX line of FIG. 4, to which a fifth cut-off pad is applied according to an exemplary embodiment of the disclosure.

### DETAILED DESCRIPTION

Regarding embodiments of the disclosure disclosed in this specification or application, the specific structural or functional description is merely illustrative for the purpose of describing the embodiments of the disclosure, and embodiments of the disclosure may be implemented in various forms but not be construed as being limited to the embodiments set forth in this specification or application.

Because the embodiments of the disclosure may be variously modified and have various forms, specific exemplary embodiments will be illustrated in the drawings and described in detail in this specification or application. However, it should be understood that embodiments of the disclosure are intended not to be limited to the specific embodiments but to cover all modifications, equivalents or alternatives without departing from the spirit and technical scope of the disclosure.

Terms such as “first” and/or “second” are used herein merely to describe a variety of elements, but the elements are not limited by these terms. Such terms are used only for the purpose of distinguishing one element from another element. For example, without departing from the conceptual scope of the disclosure, a first element may be referred to as a second, and vice versa.

When a certain element is referred to as being “connected to” or “coupled to” another element, it will be understood that they may be directly connected to or coupled to each other but or intervening elements may be present therebetween. On the other hand, when a certain element is referred to as being “directly connected to” or “directly coupled to” another element, it will be understood that no intervening elements are present therebetween. Other expressions describing relationships between elements, such as “between,” “immediately between,” “adjacent to,” “directly adjacent to,” or etc. may also be construed in the same manner.

Terms used in this specification are merely used for explaining specific embodiments, but not intended to limit the disclosure. Unless the context clearly dictates otherwise, singular forms include plural forms as well. It is to be understood that terms “include,” “have,” etc. as used herein specify the presence of stated features, integers, steps, operations, elements, components, or combination thereof, but do not preclude the presence or addition of one or more other features, integers, steps, operations, elements, components or combination thereof.

Unless defined otherwise, all terms used herein including technical or scientific terms have the same meanings as those generally understood by a person having ordinary knowledge in the art to which the disclosure pertains. The terms such as those defined in generally used dictionaries are construed to have meanings matching that in the context of related technology and, unless clearly defined otherwise, are not construed to be ideally or excessively formal.

Below, the disclosure will be described in detail by describing embodiments with reference to the accompanying drawings. Like reference numerals in the drawings refer to like numerals.

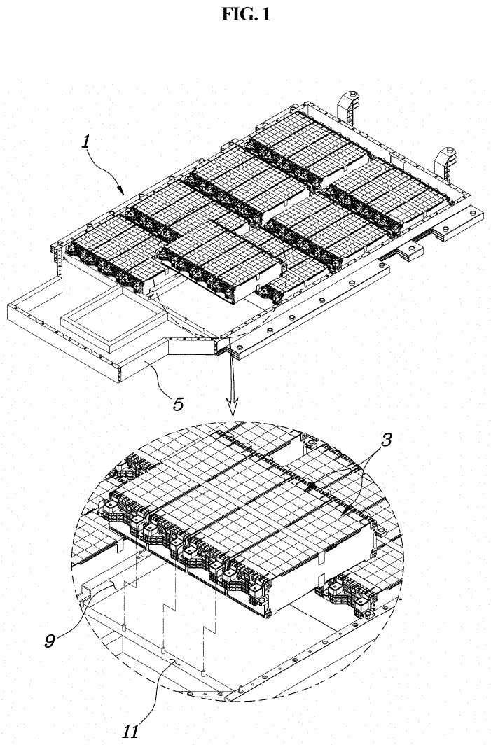

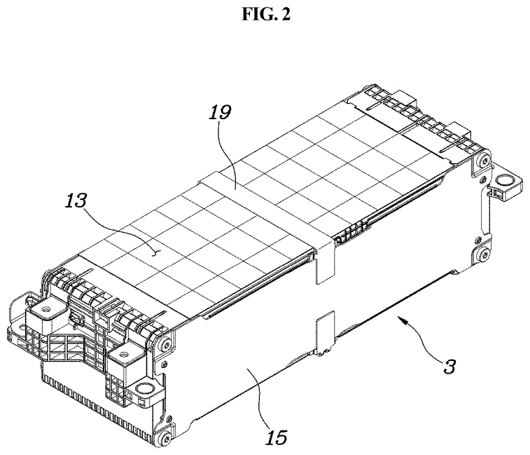

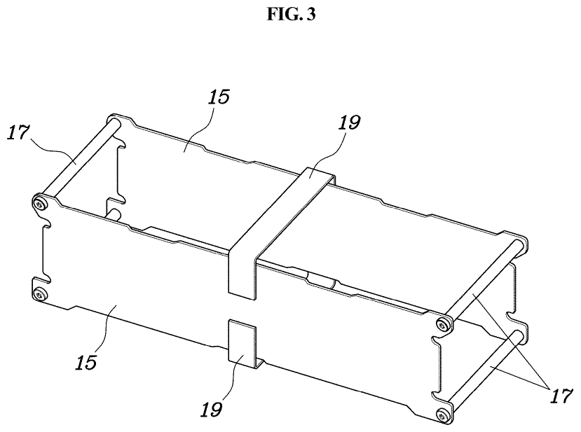

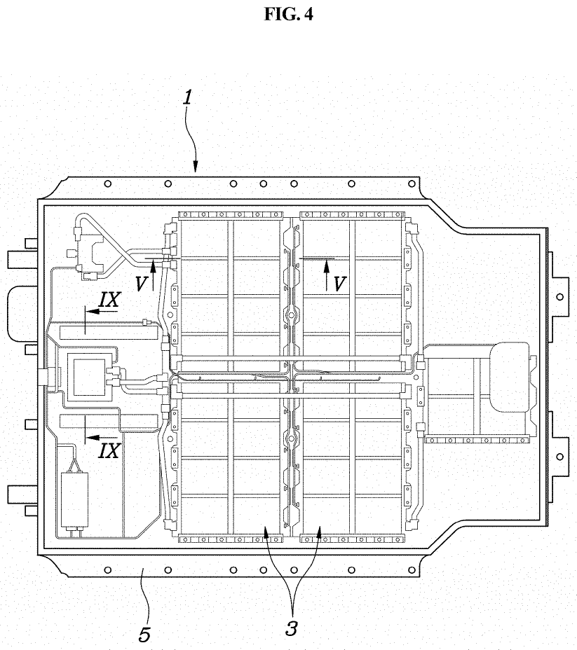

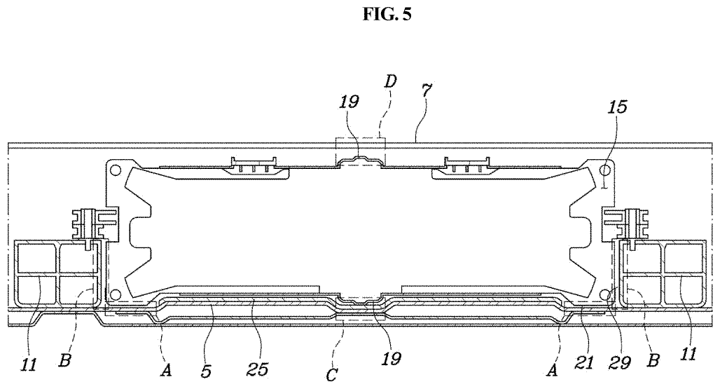

FIG. 1 illustrates a battery pack 1 of a vehicle according to an exemplary embodiment of the disclosure, FIGS. 2 and 3 illustrate a structure for a battery module 3 to be accommodated in the battery pack 1, FIG. 4 is a plan view of the battery pack 1, and FIG. 5 is a sectional view taken along line V-V of FIG. 4.

Referring to FIGS. 1 to 5, a plurality of battery modules 3 to be accommodated in the battery pack 1 are two-dimensionally arrayed to form a single layer, and these battery modules 3 are covered with a lower casing 5 at a lower side and with an upper cover 7 at an upper side.

The battery pack 1 includes a plurality of longitudinal members 9 and a plurality of cross members 11 therein between the battery modules 3 arrayed as described above, thereby improving the rigidity of the battery pack 1 and serving as a supporter or the like for holding the battery modules 3.

Here, the longitudinal member 9 is disposed lengthways in the forward and backward directions of the vehicle, and the cross member 11 is disposed lengthways in the widthwise direction of the vehicle.

The battery module 3 includes endplates 15 at opposite ends with a plurality of battery cells 13 overlapping therebetween, in which these endplates 15 are structurally connected to each other. As shown in FIG. 3, a plurality of connecting rods 17 and a plurality of clamps 19 are used for a structural connection between the endplates 15.

The connecting rods 17 are sandwiched between the opposite endplates 15 and fastened to the endplates 15 with screws, and therefore a portion of the endplate 15, to which the connecting rod 17 is fastened, protrudes outward more than other portions. Such protruding portion makes a gap with adjacent components become narrow, and therefore an electric arc is highly likely to be formed in the protruding portion.

Further, the clamps 19 are coupled to upper and lower-middle portions of the endplate 15, and also make a gap with adjacent components become narrow. Therefore, an electric arc is highly likely to be formed in the portions where the clamps 19 are positioned.

In other words, referring to FIG. 5, gaps between the lower casing 5 and the lower opposite end portions of the endplate 15 become narrow locally as shown in A, gaps between the cross member 11 and the opposite lateral end portions of the endplate 15 become narrow locally as shown in B, a gap between the lower casing 5 and the clamp 19 becomes narrow locally as shown in C, and a gap between the upper cover 7 and the clamp 19 becomes narrow locally as shown in D. Therefore, an electric arc is highly likely to be generated in A, B, C, D, and the like portions.

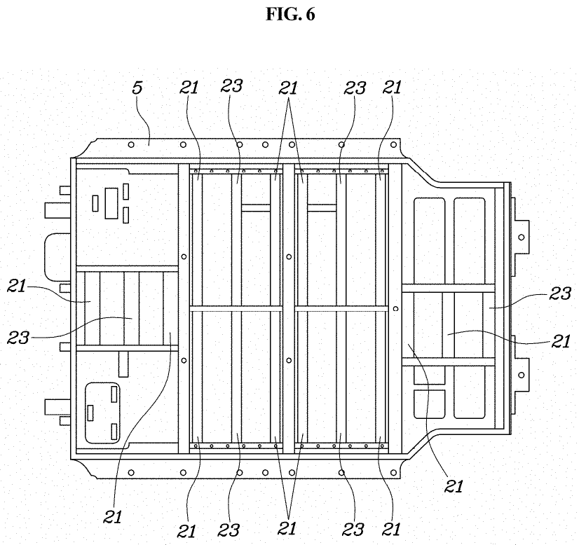

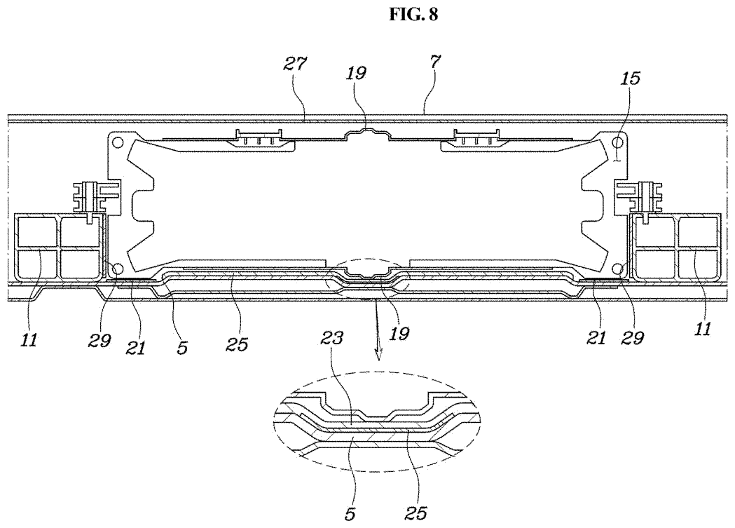

Referring to FIGS. 6 to 9, a safety structure for the battery pack 1 of the vehicle according to an embodiment of the disclosure includes a first cut-off pad 21 made of an insulating material and disposed in a portion where a gap between the endplate 15 of the battery module 3 and the lower casing 5 becomes narrow locally.

The first cut-off pad 21 may be locally provided lengthways on the top surface of the lower casing 5 in the form of a long band along a direction in which the battery modules 3 are overlapped, while facing toward the opposite end portions of the endplate 15.

Therefore, an electric arc is effectively prevented from being formed in the portion A shown in FIG. 5.

Further, a second cut-off pad 23 made of insulating material is disposed in a portion where the clamp 19 of the battery module 3 faces toward the lower casing 5.

The second cut-off pad 23 is locally attached between the first cut-off pads 21 on the top surface of the lower casing 5.

Therefore, an electric arc is effectively prevented from being formed in the portion C shown in FIG. 5.

In addition, a gap filler 25 is placed on the lower casing 5 around the portion of the battery module 3, to which the clamp 19 is coupled, and improves heat transfer between the battery cell 13 and the lower casing 5. The second cut-off pad 23 may be interposed between the gap filler 25 and the lower casing 5.

Meanwhile, a third cut-off pad 27 made of an insulating material is disposed on the inner surface of the upper cover 7 facing toward the upper side of the battery modules 3.

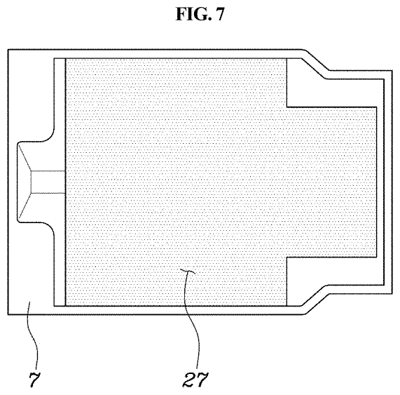

As shown in FIG. 7, the third cut-off pad 27 may be provided almost throughout the inner surface of the upper cover 7.

Therefore, an electric arc is effectively prevented from being formed in the portion D shown in FIG. 5.

Further, as described above, the plurality of longitudinal members 9 and the plurality of cross members 11 are mounted between the battery modules 3 of the battery pack 1; and whichever of the longitudinal members 9 and the cross members 11 is adjacent to the lateral end portions of the endplate 15 of the battery module 3 may be provided with fourth cut-off pads 29 made of an insulating material.

Therefore, an electric arc is effectively prevented from being formed in the portion B shown in FIG. 5.

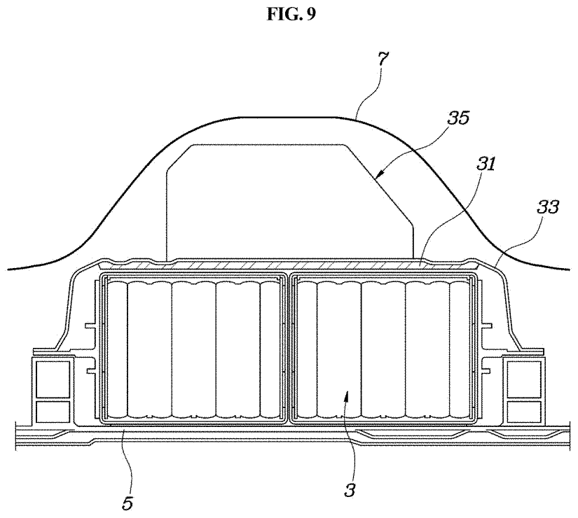

FIG. 9 is a sectional view taken along line IX-IX line of FIG. 4, to which a fifth cut-off pad 31 is applied according to an exemplary embodiment of the disclosure.

In other words, referring to FIG. 9, a mounting bracket 33 is disposed above the two-dimensionally arrayed battery modules 3 and mounted with electrical parts 35 needed for the battery pack 1; the electrical parts 35 are mounted to the upper side of the mounting bracket 33; and the fifth cut-off pad 31 made of an insulating material is disposed on a bottom surface of the mounting bracket 33.

The mounting bracket 33 allows the electrical parts 35 to be placeable in a space above the battery module 3, and therefore the portion of the upper cover 7, to which the electrical parts 35 are mounted, protrudes upward more than other portions. When this portion protrudes less to get a more compact battery pack 1, the space between the mounting bracket 33 and the battery module 3 becomes much narrower and thus an electric arc is highly likely to be generated in this portion.

Therefore, the fifth cut-off pad 31 is provided to effectively prevent an electric arc from being formed in between the lower side of the mounting bracket 33 and the upper side of the battery module 3.

The electrical parts 35 mounted to the upper side of the mounting bracket 33 may include a power relay assembly (PRA).

For reference, the first to fifth cut-off pads are made of not only the insulating material as described above to prevent the formation of an electric arc, but also a heat-resistant material to have thermal durability.

The foregoing safety structure for the battery pack 1 of the vehicle according to an exemplary embodiment of the disclosure may also be expressed as follows.

In other words, the safety structure for the battery pack 1 of the vehicle according to an exemplary embodiment of the disclosure may include the battery module 3 including the endplates 15 surrounding the opposite sides of the plurality of overlapped battery cells 13, in which the endplates 15 are connected by the clamps 19 at the upper and lower sides; the lower casing 5 surrounding the plurality of two-dimensionally arrayed battery modules 3 from below; the upper cover 7 surrounding the plurality of battery modules 3 and coupled to the lower casing 5; the plurality of longitudinal members 9 and cross members 11 coupled to the lower casing 5 and positioned between the plurality of battery modules 3; and the plurality of cut-off pads made of an insulating material and disposed in at least one among the lower casing 5, the upper cover 7, the longitudinal members 9, and the cross members 11 while facing the portions adjacent to the end plate 15 and the clamp 19 of the battery module 3.

The cut-off pads may include the first cut-off pad 21 disposed between the lower casing 5 and the endplate 15 of the battery module 3; the second cut-off pad 23 disposed between the lower casing 5 and the clamp 19 of the battery module 3; the third cut-off pad 27 disposed on the inner surface of the upper cover 7; and the fourth cut-off pad 29 disposed between the endplate 15 of the battery module 3 and the longitudinal member 9 or the cross member 11.

The first cut-off pad 21 may extend lengthways along the direction in which the battery modules 3 are overlapped, while facing toward the opposite end portions of the endplate 15.

The second cut-off pad 23 may be locally provided lengthways between the first cut-off pads 21 along the direction in which the battery modules 3 are overlapped.

The mounting bracket 33, to which the electrical parts 35 needed for the battery pack 1 are mounted, is disposed above the two-dimensionally arrayed battery modules 3.

The electrical parts 35 are mounted to a space between the mounting bracket 33 and the upper cover 7.

The fifth cut-off pad 31 made of a heat-resistant and insulating material may be disposed on the bottom surface of the mounting bracket 33.

The electrical parts 35 mounted to the space between the mounting bracket 33 and the upper cover 7 may include the PRA.

Substantially, whichever of the lower casing 5, the upper cover 7, the longitudinal member 9 and the cross member 11 needs to be provided with the cut-off pad refers to a portion that is made of a metallic material and thus potentially functions as a capacitor together with the endplate 15 or clamp 19 of the battery module 3.

In other words, the lower casing 5 or the like portion made of a metallic material serves as a potential capacitor together with the endplate 15 or the like of the battery module 3, thereby accumulating electric charges at either side. In some cases, the accumulated electric charges may form an electric arc that causes fire to break out. Accordingly, the cut-off pad fundamentally prevents such formation of an electric arc.

According to the disclosure, the possibility of an electric arc is eliminated between the battery module and its adjacent components inside the battery pack, effectively decreasing or preventing the thermal runaway and fire of the battery pack and ultimately improving the battery pack in safety significantly.

Although specific embodiments of the disclosure are illustrated and described, it will be obvious to a person having ordinary knowledge in the art that a variety of improvements and changes can be made in the disclosure without departing from the technical idea of the disclosure defined in the appended claims.

What is claimed is:

1. A safety structure for a vehicle battery pack, comprising:
a plurality of battery modules each including a plurality of battery cells stacked between opposite endplates;
a lower casing which covers a lower side of the battery modules that are two-dimensionally arrayed;
an upper cover coupled to the lower casing and covering an upper side of the battery modules; and
first cut-off pads, each of which is made of insulating material, disposed between the endplates of the battery modules and the lower casing.

2. The safety structure of claim 1, wherein the first cut-off pads are disposed in portions where gaps between the endplates of the battery modules and the lower casing become locally narrow.

3. The safety structure of claim 1, wherein the first cut-off pads are attached to a top surface of the lower casing and spaced from each other.

4. The safety structure of claim 3, wherein:
each battery module is provided as a single body by clamps respectively connecting the opposite endplates at upper and lower sides, and
a second cut-off pad made of insulating material is disposed in a space between the lower casing and the clamps of each battery module.

5. The safety structure of claim 4, wherein the second cut-off pad is attached to the top surface of the lower casing and disposed between, and spaced from, the first cut-off pads.

6. The safety structure of claim 4, further comprising a third cut-off pad made of insulating material and disposed on an inner surface of the upper cover facing the upper side of the battery modules.

7. The safety structure of claim 1, wherein
a plurality of longitudinal members and a plurality of cross members are respectively mounted between the battery modules of the battery pack; and
whichever of the longitudinal members and the cross members is adjacent to a lateral end portion of the endplates of each battery module is provided with a fourth cut-off pad made of an insulating material.

8. The safety structure of claim 1, wherein
a mounting bracket, to which electrical parts needed for the battery pack are mounted, is disposed above the two-dimensionally arrayed battery modules;
the electrical parts are mounted to an upper side of the mounting bracket; and
a fifth cut-off pad made of insulating material is disposed on a bottom surface of the mounting bracket.

9. The safety structure of claim 8, wherein the electric parts mounted to the upper side of the mounting bracket comprise a power relay assembly (PRA).

10. A safety structure for a vehicle battery pack, comprising:
a plurality of battery modules each including a plurality of overlapped battery cells, opposite sides of which are covered with endplates, the endplates being connected by clamps at upper and lower sides;
a lower casing covering the battery modules from below;
an upper cover coupled to the lower casing and covering the battery modules from above;
a plurality of longitudinal members and a plurality of cross members coupled to the lower casing and each positioned between the plurality of battery modules; and
a plurality of cut-off pads made of an insulating material and disposed in at least one of the lower casing, the upper cover, the longitudinal members or the cross members to face portions adjacent to the endplates and the clamps of each battery module.

11. The safety structure of claim 10, wherein the plurality of cut-off pads comprises:
a first cut-off pad disposed between the lower casing and the endplates of each battery module;
a second cut-off pad disposed between the lower casing and the clamps of each battery module;
a third cut-off pad disposed on an inner surface of the upper cover; and
a fourth cut-off pad disposed between the end plates of each battery module and an adjacent longitudinal member among the plurality of longitudinal members or an adjacent cross member among the plurality of cross members.

12. The safety structure of claim 11, wherein the first cut-off pad extends lengthways along a direction in which the battery modules are overlapped, and faces toward opposite end portions of the endplate.

13. The safety structure of claim 12, wherein the second cut-off pad extends lengthways along the direction in which the battery modules are overlapped, and is disposed between the first cut-off pads.

14. The safety structure of claim 11, wherein
a mounting bracket, to which electrical parts needed for the battery pack are mounted, is disposed above the two-dimensionally arrayed battery modules;
the electrical parts are mounted to a space between the mounting bracket and the upper cover; and
a fifth cut-off pad made of a heat-resistant and insulating material is disposed on a bottom surface of the mounting bracket.

15. The safety structure of claim 14, wherein the electric parts mounted to a space between the mounting bracket and the upper cover comprise a power relay assembly (PRA).

16. The safety structure of claim 10, wherein whichever of the lower casing, the upper cover, the longitudinal members and the cross members needs to be provided with the cut-off pads comprises a portion that is made of a metallic material and thus potentially functions as a capacitor together with the endplates or clamps of each battery module.

17. The safety structure of claim 16, wherein the cut-off pads are provided in whichever portion of the lower casing, the upper cover, the longitudinal members and the cross members where an electric arc causing fire is highly likely to be formed between the endplates or clamps of each battery module, so as to fundamentally prevent the formation of the electric arc.
